(19) United States
(12) Patent Application Publication
(10) Pub. No.: US 2008/0283355 A1
(43) Pub. Date: Nov. 20, 2008

(54) Hydraulic system for a vehicle

(75) Inventors: Manfred Homm, Buhl-Neusatz (DE); Eric Muller, Kaiserslautern (DE); Reinhard Stehr, Buhl (DE); Christoph Vetter, Otigheim (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Bühl (DE)

(21) Appl. No.: 11/986,978

(22) Filed: Nov. 27, 2007

Related U.S. Application Data
(60) Provisional application No. 60/861,225, filed on Nov. 27, 2006.

(51) Int. Cl. F16D 25/12

(52) U.S. Cl. 192/85 R

(57) ABSTRACT

A hydraulic system for actuating a clutch of a vehicle, in particular a commercial vehicle, having a pressure reducing valve under system pressure for pressuring the clutch with an actuating pressure in normal operation, where at least one additional reserve valve assembly is provided for emergency operation. In addition, a hydraulic system is proposed for actuating a variator of a CVT transmission of a vehicle, in particular a commercial vehicle, having at least one pressure reducing valve for pressuring a first shifting chamber and a second shifting chamber of the pulleys with an adjusting pressure to set a transmission ratio in normal operation, where at least one selector valve is connected to the first shifting chamber and the second shifting chamber of the respective pulleys.

### BACKGROUND OF THE INVENTION

1. Field of the Invention

The present invention relates to a hydraulic system for actuating a clutch of a vehicle, in particular a commercial vehicle, having a pressure reducing valve under system pressure for pressurizing the clutch with an actuating pressure in normal operation. The invention also relates to a hydraulic system for actuating a variator of a CVT transmission of a vehicle, in particular a commercial vehicle, having at least one pressure reducing valve for pressurizing a first shifting chamber and a second shifting chamber of the pulleys with an adjusting pressure for setting a transmission ratio in normal operation.

2. Description of the Related Art

Hydraulic systems for actuating clutches for passenger cars are adequately known from vehicle technology. In the known hydraulic systems a pressure reducing valve is pressurized with system pressure and sets a desired operating pressure at the clutch depending on the driving situation, in order to actuate the clutch accordingly.

In particular in the case of commercial vehicles, such as trucks, it has been found that when the electronics or a valve fail there is no assurance that the clutch will remain engaged. But this is absolutely essential, in order to be able to continue utilizing the engine braking effect with the vehicle. Only shortly before stopping, when the engine braking effect is no longer needed, must the clutch be disengaged again, so that the engine does not stall, but the transmission continues to be supplied with oil.

Also known from vehicle technology is a hydraulic system for actuating a variator of a CVT transmission for a vehicle. The known hydraulic system includes one or more pressure reducing valves for pressurizing the shifting chambers of the pulleys of the variator in order to realize a desired shifting pressure to set a transmission ratio.

It has been found that the variator of the CVT transmission can shift abruptly and very quickly when the electrical system fails. This can result in the transmission being damaged, or in the transmission ratio being shifted in such a way that the driving wheels are blocked. It is also possible for the variator to be shifted in the direction of overdrive, so that the engine braking effect no longer exists.

In view of the disadvantages known from the existing art, the object of the present invention is thus to propose a hydraulic system of the species named at the beginning that realizes a safety concept for vehicles, in particular for commercial vehicles.

### SUMMARY OF THE INVENTION

This problem is solved by a hydraulic system for actuating a clutch of a vehicle, in particular a commercial vehicle, having a pressure reducing valve under system pressure for pressurizing the clutch with an actuating pressure in normal operation, where at least one additional reserve valve assembly is provided for emergency operation.

In this way the actuation of the clutch is redundant in its design; that is, in the hydraulic system according to the invention there are two pressure supply sources that can apply oil under pressure to the clutch and thereby engage the clutch. This means that the electrically actuated pressure reducing valve for example ensures the pressure supply to the clutch in normal operation, and a second valve for example ensures the pressure supply to the clutch in emergencies, quasi in reserve, if the pressure reducing valve is non-functional.

Within the framework of an advantageous embodiment of the invention, it can be provided that the reserve valve assembly for emergency operation and the pressure reducing valve for normal operation both be connected to a reversing valve or the like. It is then possible using the reversing valve to switch between normal mode and emergency mode, so that the reserve valve assembly can be activated in the event of an electric power failure. In an advantageous manner, the vehicle can thus be operated even without the electrical actuation of the pressure reducing valve, since actuation of the clutch by the reserve valve assembly is ensured.

A 3/2 directional valve or the like can be used preferably as the reversing valve, to which on the one hand the reserve valve assembly and on the other hand the pressure reducing valve for normal operation are connected. The reversing valve has two selector positions, namely the normal mode position and the emergency mode position. In the normal mode position the connection of the pressure reducing valve is linked with the connection to the clutch. When the emergency mode position is in effect, the connection of the reserve valve assembly is linked with the connection of the clutch.

According to a next refinement of the invention, the reserve valve assembly includes a metering orifice that is connected to the main oil stream, and a pressure reducing valve or the like for actuating the clutch in emergency mode. Since the metering orifice is situated in the main oil volume stream, which is dependent on the engine rotation speed, the pressure reducing valve utilizes the engine rotation speed as the signal for engaging the clutch in emergency mode. This is achieved by the fact that the metering orifice produces a pressure difference in the main oil stream which is used as a controlling variable for the pressure reducing valve, with the pressure reducing valve supplying a corresponding clutch pressure to actuate the clutch, depending on this controlling variable. Other actuating options are also possible for the emergency mode.

In order to be able to reduce the pressure drop produced by the metering orifice, it is possible within the framework of a different embodiment of the invention to provide for at least one pressure limiting valve or the like to be provided. Preferably, the pressure limiting valve can be situated parallel to the metering orifice. Other arranging options are also conceivable. Through the use of a pressure limiting valve, the clutch pressure in emergency mode can be kept within certain bounds even at higher rotational speeds.

The proposed hydraulic system, which provides a clutch pressure in emergency mode that depends on the engine speed, is able to realize an optimal adaptation to the particular requirements with the metering orifice, the pressure translation of the pressure reducing valve, with the bias spring of the pressure reducing valve and the opening pressure of the bypass valve or pressure limiting valve.

Preferably, the metering orifice situated in the main oil stream can be situated directly after the main oil pump, with the possibility of individual consumers being picked up even before the metering orifice. In vehicle transmissions, speed limiting valves are often used, which limit the stream of oil by the controller and above a certain speed of rotation divert part of the volume conveyed by the system pressure pump to the supply tank or to low-pressure consumers, such as lubrication or the like. These speed limiting valves also use a metering orifice in the main oil stream. It is therefore advantageously possible for this metering orifice which is already present to also be used at the same time for the reserve valve assembly. That makes it possible to save components. Another advantage of this arrangement option is that because of reduction of the speed limiting valve the pressure difference through the metering orifice remains constant after a certain speed of rotation, so that the pressure limiting valve can then be eliminated.

It is also possible for example for a second metering orifice to be situated in the limiting oil stream, which is used exclusively for actuating the reserve valve assembly. When this second metering orifice is provided in addition to the first metering orifice, the second metering orifice is activated only above the limiting point, and then has no influence itself on the pump pressure, since it is situated in the low pressure circuit. If the pressure after the second metering orifice does not correspond to the supply tank pressure, the second metering orifice should be connected with the pressure reducing valve. Otherwise this return routing can be skipped.

The problem underlying the invention is also solved by a hydraulic system for actuating a variator of a CVT transmission of a vehicle, in particular of a truck, having at least one pressure reducing valve for pressurizing a first shifting chamber and a second shifting chamber of the respective pulleys with an adjusting pressure to set a transmission ratio in normal mode, there being at least one reversing valve or the like situated ahead of the shifting chambers of the pulleys.

In this way it is possible in normal mode with one or with two pressure reducing valves to apply an adjusting pressure to the first pulley or to the second pulley, in order to set the transmission ratio accordingly. In the event of a failure of the electric power or of a pilot valve, with the hydraulic system according to the invention it is possible to produce a corresponding adjusting pressure in the shifting chambers of the pulleys through the selector valve, so that unwanted adjustments of the variator are avoided, whereby the occurrence of dangerous driving situations in the vehicle is reliably prevented.

Within the framework of an advantageous variant embodiment of the invention it can be provided that the selector valve is held against a spring force in a normal mode position with at least one, preferably two pilot pressures.

In this way it is possible even in an emergency to hold the normal mode position, in which the two adjusting pressures can be connected through to the respective shifting chambers as needed. Using two pilot pressures results in the advantage that in emergency mode, even if one of the two pilot pressures is shut off the selector valve is nevertheless held in its normal mode position. The pilot pressures used can thus also fulfill additional tasks outside of the holding function on the selector valve.

The hydraulic system according to the invention provides the assurance that in an emergency sufficient system pressure will always be built up to shift the variator of the CVT transmission in the direction of the underdrive transmission ratio. The selector valve thus has two selector positions, namely normal mode, in which the two pressure reducing valves are each connected to a shifting chamber of the pulleys; the second selector position is emergency mode, in which the connection of the first shifting cylinder is blocked, while the second shifting cylinder is preferably connected to the system pressure line through an orifice plate or the like.

The use of an orifice plate or similar component has the advantage that the shifting of the variator is significantly slowed, so that controllable driving behavior of the vehicle is ensured. For slowest possible shifting the dimensions of the metering orifice should be small, and preferably should be protected from possible fouling by placing a filter or screen in front of it.

The hydraulic systems proposed according to the invention for the clutch actuation and for the variator actuation can also be combined with each other. Preferably the hydraulic systems are employed as safety concepts for trucks or heavy trucks. Other possible applications are also conceivable, however.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic partial view of a hydraulic system according to the invention for actuating a clutch of a truck;

FIG. 2 is a schematic partial view of a first embodiment of a reserve valve assembly of the hydraulic system according to FIG. 1;

FIG. 3 is a schematic view of a next embodiment of the reserve valve assembly of the hydraulic system according to FIG. 1;

FIG. 4 is a schematic view of another embodiment of the reserve valve assembly of the hydraulic system according to FIG. 1; and

FIG. 5 is a schematic partial view of a hydraulic system for actuating a variator of a CVT transmission.

### DESCRIPTION OF THE PREFERRED EMBODIMENTS

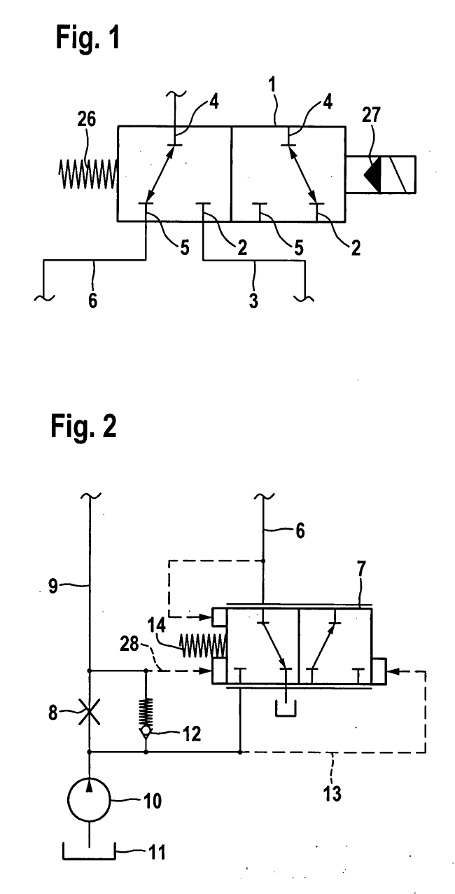

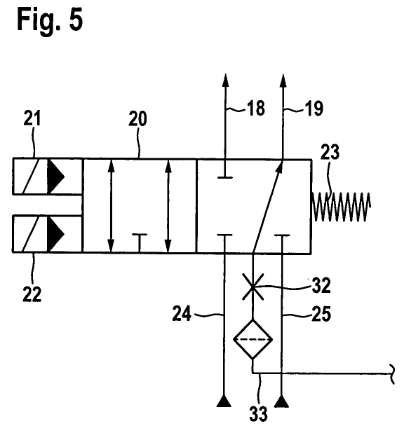

Various embodiments of a hydraulic system for actuating a motor vehicle clutch are shown in FIGS. 1 through 4. FIG. 5 shows another hydraulic system, but for actuating a variator of a CVT transmission for a truck.

The proposed hydraulic system for actuating a clutch of a truck intended as a commercial vehicle includes a pressure reducing valve, not illustrated further in the figures, with which an operating pressure is applied to the clutch in normal mode in order to be able to engage the clutch, and a reserve valve assembly for the emergency mode.

In accordance with the invention, redundant actuation of the clutch is guaranteed in the hydraulic system. To that end a reversing valve 1 is provided, to which the pressure reducing valve for the pressure supply of the clutch in normal mode, not shown in further detail, and the reserve valve assembly for the pressure supply of the clutch in emergency mode shown in FIGS. 2 through 4, are connected.

Reversing valve 1 is designed as a 3/2 directional valve, with the pressure reducing valve connection 2 being connected to the clutch line connection 4 in a first selector position in normal mode. Pressure reducing valve connection 2 is connected to the pressure reducing valve through a connecting line 3.

In order to ensure engaging of the clutch in the event of an electric power failure, in a second selector position of reversing valve 1 a reserve valve assembly connection 5 is connected to clutch line connection 4. Reserve valve assembly connection 5 is connected via a connecting line 6 to a pressure reducing valve 7 of the reserve valve assembly.

The first selector position of reversing valve 1 thus corresponds to normal mode and the second selector position of reversing valve 1 corresponds to emergency mode, in order to ensure engaging of the clutch in every state of the vehicle.

Reversing valve 1 is actuated against a spring 26 by means of an electromagnetic assembly 27. In this way, because of the spring force of spring 26 the emergency mode can be introduced even in the event of an electric power failure without actuating the electromagnetic assembly, in order to ensure engaging of the clutch.

FIG. 2 depicts a first embodiment of the reserve valve assembly. The reserve valve assembly includes pressure reducing valve 7, which is likewise designed as a 3/2 directional valve. In this embodiment the reserve valve assembly also includes a metering orifice 8, which is situated in the main oil line 9 of the hydraulic system. Metering orifice 8 is situated directly after the main oil pump 10, which is supplied with oil from a supply tank 11. Metering orifice 8 produces a pressure difference from the rotational-speed-dependent pump volume oil stream, which acts as a control variable on pressure reducing valve 7, which is indicated by a dashed line 28 in FIG. 2.

In this way pressure reducing valve 7 can supply a clutch pressure depending on the control variable, which pressure is forwarded through connecting line 6 to reversing valve 1 in emergency mode. As a result, the engaging of the clutch depending on the engine speed is enabled or ensured by the reserve valve assembly in emergency mode.

In addition, in this embodiment a pressure limiting valve 12 is situated parallel to metering orifice 8. Pressure limiting valve 12 can limit the pressure drop at metering orifice 8, so that the clutch pressure which is supplied by pressure limiting valve 7 is also limited at a higher speed of rotation, which is indicated in FIG. 2 by the dashed line 13. The pressure limiting valve 12 or bypass valve limits the clutch pressure to a maximum value. In addition, pressure limiting valve 7 includes a bias spring 14, which likewise makes it possible to adapt the clutch pressure to the particular demands.

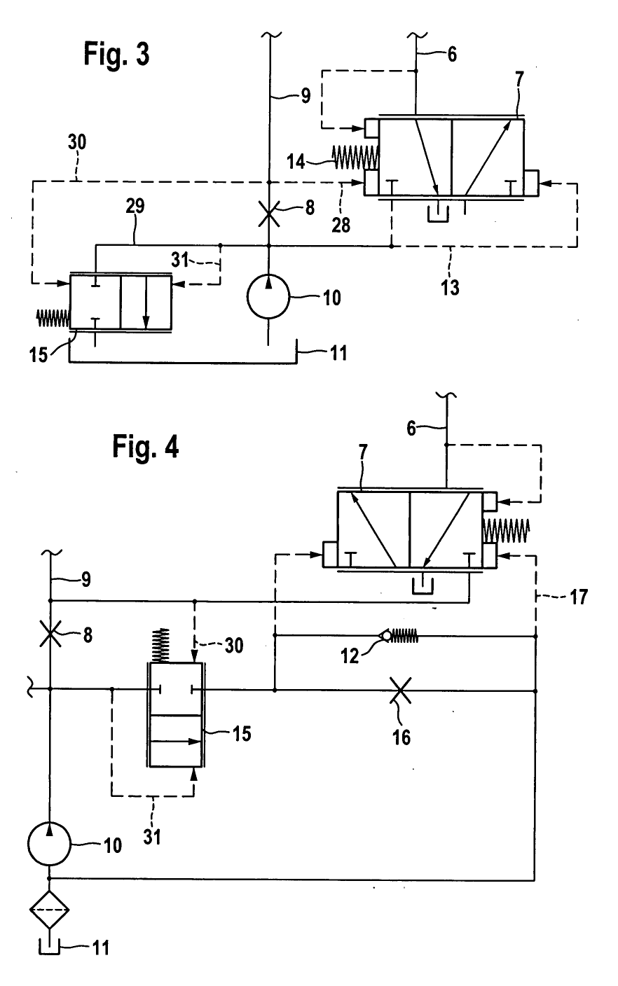

FIG. 3 shows another embodiment of the reserve valve assembly, in which in contrast to the embodiment according to FIG. 2 an already existing metering orifice of a speed limiting valve 15 is utilized as metering orifice 8. Speed limiting valve 15 serves in this case to limit the oil flow through the controller, and above a certain speed of rotation to divert part of the volume conveyed by the system pressure pump 10 through a connecting line 29 to supply tank 11 or to low pressure consumers, such as a lubricating unit or the like. The transmissions of control variables to actuate limiting valve 15 are indicated by the dashed lines 30, 31 in FIG. 3.

Since the limiting valve 15 already requires a metering orifice 8, the latter can also be used simultaneously for the reserve valve assembly or for pressure reducing valve 7. In this embodiment pressure limiting valve 12 can be eliminated, since above a certain speed of rotation the pressure difference through metering orifice 8 remains constant due to the limiting of limiting valve 15.

FIG. 4 shows another embodiment of the reserve valve assembly in which, in contrast to the embodiment shown in FIG. 3, another second metering orifice 16 is provided. Hence with this embodiment a second metering orifice 16 can optionally also be employed in the limiting oil stream of the limiting valve 15. It can only become active above the limiting point of the limiting valve, and then no longer has any influence itself on the pump pressure, since it is located in the low pressure circuit. If the pressure after the second metering orifice 16 does not correspond to the supply tank pressure, this pressure too must be returned to pressure reduction valve 7, which occurs through line 17, as shown in FIG. 4.

FIG. 5 shows a schematic view of a hydraulic system for actuating a variator of a CVT transmission for a truck, with the variator of the CVT transmission not being shown in further detail.

In normal mode, a corresponding adjusting pressure is applied to the variator by one or two electrically operated pressure reducing valves or shifting cylinders, which are not shown in further detail, either at the first shifting chamber 18 of the first pulley or at the second shifting chamber 19 of the second pulley, depending on the operating point, in order to set a desired transmission ratio.

In order to realize a safety concept with this hydraulic system as well, provision is made according to the invention for a selector valve 20 to be situated ahead of the two shifting chambers 18, 19 of the pulleys. Selector valve 20 is held in the normal mode position against a bias spring 23 by two pilot pressures through a first pilot pressure connection 21 and a second pilot pressure connection 22. In the normal mode position, the adjusting pressures that are supplied through connecting lines 24, can be connected at will through selector valve 20 to shifting chambers 18, 19. Even if one pilot pressure is lost, selector valve 20 remains in this normal mode selector position.

Selector valve 20 is not moved to the emergency mode position by the spring force of bias spring 23 until both pilot pressures fail or are shut off at the pilot pressure connections 21, 22. In the emergency mode selector position of selector valve 20 the connection to the first shifting chamber 18 is blocked, while the connection to the second shifting chamber 19 is subjected via an orifice plate 32 to system pressure through system pressure line 33.

The hydraulic system in accordance with the invention ensures that in emergency mode sufficient system pressure is always built up to shift the variator toward underdrive. Through the use of the orifice plate 32 the shifting is slowed down in such a way that optimal driving behavior of the truck is ensured.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for actuating a clutch of a vehicle, said system comprising: a pressure reducing valve under system pressure for pressurizing the clutch with an actuating pressure in normal operating mode, wherein at least one additional reserve valve assembly is provided for emergency operation.

2. A hydraulic system in accordance with claim 1, wherein the reserve valve assembly for the emergency mode and the pressure reducing valve for the normal mode are connected to a reversing valve.

3. A hydraulic system in accordance with claim 2, wherein the reversing valve is a 3/2 directional valve, where in a first selector position in normal mode a pressure reducing valve connection is connected to a clutch line connection, and where in a second selector position in emergency mode a reserve valve assembly connection is connected to the clutch line connection.

4. A hydraulic system in accordance with claim 1, wherein with the reserve valve assembly the engine speed of the vehicle is provided as a controlling variable for engaging the clutch in emergency mode.

5. A hydraulic system in accordance with claim 1, wherein the reserve valve assembly includes a metering orifice connected to a main oil stream, and a pressure reducing valve for actuating the clutch in emergency mode.

6. A hydraulic system in accordance with claim 5, wherein the pressure reducing valve includes a bias spring.

7. A hydraulic system in accordance with claim 5, wherein the metering orifice is coupled with the pressure reducing valve in such a way that the pressure difference produced by the metering orifice is provided as a controlling variable for the pressure reducing valve.

8. A hydraulic system in accordance with claim 1, wherein a pressure limiting valve is situated parallel to the metering orifice.

9. A hydraulic system in accordance with claim 5, wherein the metering orifice is situated directly after the main oil pump in the main oil line.

10. A hydraulic system in accordance with claim 5, wherein the metering orifice is usable in addition for a reducing valve.

11. A hydraulic system in accordance with claim 5, wherein a second metering orifice is situated in the oil stream of a reducing valve.

12. A hydraulic system in accordance with claim 11, wherein the second metering orifice is connected to the pressure limiting valve.

13. A hydraulic system in accordance with claim 11, wherein the second metering orifice is connected directly to the pressure reducing valve.

14. A hydraulic system for actuating a variator of a CVT transmission of a vehicle, said system comprising: at least one pressure reducing valve for pressurizing a first shifting chamber and a second shifting chamber of an axially movable pulley of the transmission with an adjusting pressure for setting a transmission ratio in normal operation, wherein at least one selector valve is connected to the first shifting chamber and the second shifting chamber of the respective pulleys.

15. A hydraulic system in accordance with claim 14, wherein the selector valve is held against the spring force of a bias spring in a normal mode position with at least one pilot pressure.

16. A hydraulic system in accordance with claim 15, wherein the selector valve includes a first pilot pressure connection and a second pilot pressure connection.

17. A hydraulic system in accordance with claim 16, wherein the emergency mode can be activated when both pilot pressures are shut off at the pilot pressure connections of the selector valve.

18. A hydraulic system in accordance with claim 14, wherein in emergency mode the first shifting chamber is separated from the adjusting pressure connecting line, and that the second shifting chamber is connected to a system pressure line.

19. A hydraulic system in accordance with claim 18, wherein the second shifting chamber is connected through an orifice plate to the system pressure line for pressurizing with system pressure.

20. A hydraulic system in accordance with claim 19, wherein at least one of a filter and a screen is situated ahead of the orifice plate.
